(19) United States
(12) Patent Application Publication
(10) Pub. No.: US 2021/0141349 A1
(43) Pub. Date: May 13, 2021

(54) INTERCHANGEABLE MULTIMODAL HUMAN INTERACTION SYSTEM

(71) Applicant: Samsung Electronics Co., Ltd., Suwon-si (KR)

(72) Inventor: Pranjal Subhash Jain, San Jose, CA (US)

(21) Appl. No.: 16/749,927

(22) Filed: Jan. 22, 2020

Related U.S. Application Data
(60) Provisional application No. 62/933,195, filed on Nov. 8, 2019.

(51) Int. Cl. G05B 15/02; G06K 9/00

(52) U.S. Cl. CPC G05B 15/02; G16Y 40/30; G06K 9/00335

(57) ABSTRACT

A system and method for controlling an electronic device via physical interactions. A first user physical interaction is provided at a first point in time, and a second physical interaction is provided at a second point in time. If the first user physical interaction is of a first type, a device is identified based on the first user physical interaction, and a command is identified based on the second user physical interaction where the second user physical interaction is of a second type. If the first user physical interaction is of the second type, the command is identified based on the first user physical interaction, and device identification is via a third user physical interaction received at the second point in time.

### CROSS-REFERENCE TO RELATED APPLICATION(S)

The present application claims priority to and the benefit of U.S. Provisional Application No. 62/933,195, filed Nov. 8, 2019, entitled “INTERCHANGEABLE MULTIMODAL HUMAN INTERACTION SYSTEM,” the entire content of which is incorporated herein by reference.

### FIELD

One or more aspects of embodiments according to the present disclosure relate to human interaction systems, and more particularly, to a system and method for human interaction that uses a multimodal approach to naturally interact with consumer electronic devices.

### BACKGROUND

With the advent of smart home systems and Internet of Things (IoT), many electronic devices in a home can be connected to the Internet and can be monitored and controlled remotely. In addition to being controlled remotely, more and more of these devices can now be controlled via human physical interactions (e.g. gestures, voice, eye movement, and the like). Using a traditional multimodal human interaction approach, two or more physical inputs from a user are invoked in a coordinated manner to interact with the device. In the traditional system, the type of physical inputs that can be used, and the order of such physical inputs, however, are often preset. For example, one type of input (e.g. gesture) may be required to be provided first to select the device, and another type of input (e.g. voice) may be required to be provided next to control the device. Forcing a user to follow a predetermined sequence of physical inputs may lead to unnatural interactions for some, making such interactions clumsy and prone to errors. For some, a more natural interaction may entail providing voice and gesture together, or voice followed by gesture. In order to allow all users to interact naturally, the order of interactions should not be predefined.

Multimodal human interactions can also be challenging when there are multiple devices in a closed space that could be controlled via such interactions, and/or there are multiple users in the room. The control of the devices in these situations may often be unreliable. For example, multiple devices may be triggered via a user's gesture when the devices are in close proximity to one another. When more than one device is triggered at once, there is ambiguity as to whether a control command that follows the gesture is directed to one device as opposed to the other.

Thus, what is desired is a multimodal human interaction system that allows a user to interact with devices in a closed space without adhering to a predefined sequence of inputs, which results in a more natural and reliable interaction with the devices.

### SUMMARY

Embodiments of the present disclosure are directed to a method for controlling an electronic device. The method includes monitoring and receiving a first user physical interaction, where the first user physical interaction is provided at a first point in time. A type of the first user physical interaction is determined, and in response to determining that the first user physical interaction is of a first type, a device is identified based on the first user physical interaction provided at the first point in time. A session is started for the device. While the session is unexpired, a second user physical interaction of a second type is monitored for and received, where the second user physical interaction is provided at a second point in time, and the second type is different from the first type. A command is identified based on the second user physical interaction provided at the second point in time.

In response, however, to determining that the first user physical interaction is of the second type, the command is identified based on the first user physical interaction provided at the first point in time. The command is stored in a data store, and the session is started for the device. While the session is unexpired, a third user physical interaction of the first type is monitored for and received, where the third user physical interaction is provided at the second point in time. The device is identified based on the third user physical interaction provided at the second point in time, and the command is transmitted for controlling the device according to the command.

In one embodiment, the first type is a gesture or eye movement, and the second type is voice.

In one embodiment, the starting the session for the device includes determining that an unexpired session exists for another device; identifying a state of the unexpired session; and starting the session based on the state of the unexpired session.

In one embodiment, a camera is invoked on a mobile device; images of the device and a plurality of other electronic devices in an enclosed space are detected via the camera; and a location of the device and each of the plurality of other electronic devices relative to a second camera invoked for identifying gestures of a user, are automatically determined.

In one embodiment, the first, second, and third user physical interactions are determined to be directed to a second device other than the device, and the identifying of the device includes retrieving information correlating the second device to the device.

In one embodiment, the first point in time is concurrent with the second point in time.

In one embodiment, the second point in time is later than the first point in time.

In one embodiment, the command is for modifying an attribute of the device.

In one embodiment, in response to determining that the first user physical interaction is of the first type, a state machine associated with the device is transitioned to a state that expects a next physical interaction from a user corresponding to a control command.

In one embodiment, in response to determining that the first type of interaction is of the second type, a state machine associated with the device is transitioned to a state that expects a next physical interaction from the user corresponding to selection of a particular device.

Embodiments of the present disclosure are also directed to a system for controlling an electronic device. The system includes one or more processors, and one or more memory devices coupled to the one or more processors, where the one or more memory devices store therein instructions that, when executed by the one or more corresponding processors, cause the one or more processors to respectively: monitor and receive a first user physical interaction, wherein the first user physical interaction is provided at a first point in time; determine a type of the first user physical interaction; in response to determining that the first user physical interaction is of a first type: identify a device based on the first user physical interaction provided at the first point in time; start a session for the device; while the session is unexpired, monitor and receive a second user physical interaction of a second type, wherein the second user physical interaction is provided at a second point in time, the second type being different from the first type; and identify a command based on the second user physical interaction provided at the second point in time; and in response to determining that the first user physical interaction is of the second type: identify the command based on the first user physical interaction provided at the first point in time; store the command in a data store; start the session for the device; while the session is unexpired, monitor and receive a third user physical interaction of the first type wherein the third user physical interaction is provided at the second point in time; and identify the device based on the third user physical interaction provided at the second point in time; and transmit the command for controlling the device according to the command.

Embodiments of the present disclosure are further directed to a system for controlling an electronic device, the system comprising: a camera configured to detect physical interactions of a first type; a microphone configured to detect physical interactions of a second type; one or more processors coupled to the camera and microphone; one or more memory devices coupled to the one or more processors, wherein the one or more memory devices store therein instructions that, when executed by the one or more corresponding processors, cause the one or more processors to respectively: monitor and receive a first user physical interaction, wherein the first user physical interaction is provided at a first point in time; determine a type of the first user physical interaction; in response to determining that the first user physical interaction is of a first type: identify a device based on the first user physical interaction provided at the first point in time; start a session for the device; while the session is unexpired, monitor and receive a second user physical interaction of a second type, wherein the second user physical interaction is provided at a second point in time, the second type being different from the first type; and identify a command based on the second user physical interaction provided at the second point in time; and in response to determining that the first user physical interaction is of the second type: identify the command based on the first user physical interaction provided at the first point in time; store the command in a data store; start the session for the device; while the session is unexpired, monitor and receive a third user physical interaction of the first type wherein the third user physical interaction is provided at the second point in time; and identify the device based on the third user physical interaction provided at the second point in time; and transmit the command for controlling the device according to the command.

As should be appreciated by a person of skill in the art, the system and method for a multimodal human interaction according to the various embodiments of the present disclosure allow a user to interact with devices in a closed space, without adhering to a predefined sequence of inputs, leading to a more natural way of interacting with the devices. Also, the session-based approach of interacting with the devices result in a more reliable interaction with the devices.

### BRIEF DESCRIPTION OF THE DRAWINGS

These and other features and advantages of the present disclosure will be appreciated and understood with reference to the specification, claims, and appended drawings wherein:

FIG. 1 is a conceptual diagram of an interchangeable multimodal human interaction system according to one exemplary embodiment;

FIG. 2 is a block diagram of various components of the interchangeable multimodal human interaction system of FIG. 1 according to one exemplary embodiment;

FIG. 3 is a state diagram of a state machine for enabling control of devices in a room via interchangeable multimodal human interactions according to one exemplary embodiment;

FIG. 4 is a flow diagram of a process for interchangeable multimodal interactions with devices in a room that includes a proxy device according to one exemplary embodiment; and

FIG. 5 is a flow diagram of a process for generating a 3D map of objects in a room 100 according to an exemplary embodiment.

### DETAILED DESCRIPTION

In general terms, embodiments of the disclosure are directed to controlling electronic devices in a room (or other enclosed space), via physical interactions of a user. The user interacts with the devices using a multimodal approach that invokes two or more types of physical interactions. However, instead of requiring that the multimodal interactions follow a preset sequence, such as, for example, gesture followed by voice, the multimodal interaction according to embodiments of the disclosure can be performed concurrently or in any order. For example, the user may start with a gesture followed by voice, or start with voice followed with a gesture, or provide both gesture and voice concurrently. This allows the interactions to be more natural, catering to the preferences of the interacting user.

In some embodiments, the multimodal interactions are conducted using a session-based approach. In one embodiment, when a device in a room is selected for interaction, a session with that device is activated. Interaction with the device occurs while the session is active (e.g. has not expired or terminated). In some embodiments, another device in the room waits for the session to complete before interaction with that other device is possible. In yet other embodiments, interaction with the other device is not possible until the communication with the first device has progressed to a certain state during the communication session (e.g. device control state). This helps increase reliability of multimodal interactions in an environment where multiple people may be interacting with multiple devices in the same room.

In some embodiments a multimodal interaction may occur indirectly with devices that may be outside of the room, or otherwise hidden from sight. In one embodiment, a proxy device in the room represents the device that is outside of the room or hidden from sight (hereinafter referred to as the “represented or linked device”). The proxy device may or may not be a device that can be directly controlled via remote physical interactions. A data store record correlates or links the proxy device to the represented device that is to be remotely controlled. Multimodal interactions in any desired sequence are directed to the proxy device. As the user engages in the multimodal interaction with the proxy device, corresponding commands may be transmitted for controlling the represented device.

In some embodiments, the control of the devices via multimodal human physical interactions is hardware agnostic. Although the devices are deployed on different hardware platforms and may employ different technologies, interaction with such devices may still be possible using a uniform set of gestures and commands, irrespective of the order of such gestures or commands.

FIG. 1 is a conceptual diagram of an interchangeable multimodal human interaction system according to one exemplary embodiment. The system includes various connected electronic devices 102a-102e (collectively referred to as 102) in an enclosed environment such as, for example, a room 100. Although a room is used as an example, a person of skill in the art should recognize that the embodiments are not limited to a room, but may extend to other enclosed areas such as cars, drones, and the like. Embodiments of the invention may also extend to controlling other types of electronic devices including home assistants, tablets, AR/VR devices, and the like.

The connected devices 102 may be electronic appliances that are wired or wirelessly connected to each other over a wired or wireless data network. In one example, the electronic appliances are IoT devices that are applied in home or office automation applications. Such electronic appliances may include, without limitation, a thermostat 102a, television 102b, lamp 102c, fan 102d, and refrigerator 102e.

In one embodiment, the connected devices 102 are controlled remotely through the wired or wireless data network. The wired network may employ, for example, a HomePNA Alliance (Home Phoneline Networking Alliance) technology that employs existing coaxial cables and telephone wiring within the home. The wireless network may employ, for example, radio frequency (RF) technology, private area network (e.g. Bluetooth) technology, IrDA (Infrared Data Association) technology, wireless LAN (WiFi) technology, and/or the like.

Some of the devices (e.g. devices 102a,102b) have full network connectivity for communicating with other devices over the data network, while other devices (e.g. devices 102c-102e) may be connected to the data network through a hub 106. The hub 106 may function as a bridge to enable these devices 102c-102e to be connected to the data network. In this manner, these devices 102c-102e may be controlled and operated through the hub 106 without requiring that the device implement full network communication capability.

The interchangeable multimodal human interaction system may also include a server 108 coupled to the one or more of the connected devices 102 over the data network. If the devices do not have full network communication capability, the communication to the server 108 may be, for example, via the hub 106. In one embodiment, the server 108 stores information about the connected devices that allows those devices to be remotely monitored and controlled by the server. The server may also store configuration and location information of various devices in the room, including information about connected and non-connected devices.

In one embodiment, the connected devices 102 are disposed in different locations within the room 100. A human person/user 104 in the room interacts with the devices via multimodal interactions using two or more physical inputs including, for example, gesture and voice, gesture and eye movement (gaze), or gaze and voice. The physical inputs may be provided concurrently or in any desired order that may come naturally to the user.

As the user engages in the multimodal interactions, the interactions are captured by a camera 109 and/or a microphone 110. The camera and/or the microphone 110 may be incorporated, for example, in the television 102b. In other embodiments, the camera 109 and/or microphone 110 are incorporated in one or more of the other connected devices 102 in the room. The camera and/or microphone may also be a stand-alone device (not shown).

In one embodiment, the microphone 110 is configured to receive audio utterances of the user, and the camera 109 is configured to receive video of gesture motions and/or eye movements of the user. In one embodiment, the camera is a 3D depth camera that is capable of judging depth and distance of images captured with the camera. In one embodiment, the camera 109 is triggered for capturing gesture information when a certain threshold image of the user is obtained. The threshold image may be, for example, a head of the user, or the head of the user along with a hand.

In one embodiment, the television 102b further includes a controller 111 that enables the interchangeable multimodal human interactions with the devices in the room. In this regard, the television 102b includes a processor, and a memory that hosts the controller 111 as a software module. In alternative embodiments, the controller 111 is implemented in hardware, firmware (e.g. ASIC), or a combination of software, hardware, and firmware.

In one embodiment, the controller 111 monitors for human physical interactions from the user 104 for controlling/modifying an aspect/attribute of one of the connected devices 102 in the room. For example, the physical interaction may be for powering on/off the device, raising/lowering volume/temperature, opening/closing the device, and/or the like. Upon detecting such human physical interactions, the controller 111 generates and transmits appropriate input commands over the data network for effectuating the desired function on the device.

Although in the embodiment of FIG. 1, the controller 111 is deemed to be hosted in by the television 102b, a person of skill in the art should recognize that the controller 111 may be incorporated into another connected device 102 in the room 100. For example, instead the controller 111 being hosted by the television 102b, the controller may be hosted by the hub 106. The controller 111 may also be hosted in a stand-alone computer system.

In addition to the connected devices 102, the room 100 may also contain a proxy device 112 that is correlated or linked to another connected device 114 (e.g. washing machine) that is hidden from view of the user 104 (e.g. a device in a room other than the room 100). The proxy device 112 may be a household appliance (e.g. speaker system) or object (e.g. painting) in the room 100 that is not connected to the data network and not controllable via remote human interactions. The user 104 directs physical interactions to the proxy device 112, and the interactions are then used to control the device 114 that is linked to the proxy device. For example, the user may point to the proxy device 112 and utter a voice command, concurrently or in any order, and the controller 111 transmits signals for controlling the connected device 114 (e.g. washing machine) in the other room instead of the proxy device itself.

In some embodiments, the proxy device 112 is another connected device (e.g. one of connected devices 102) which may itself be controlled via remote human interactions. In this embodiment, commands that are to control the proxy device 112 as opposed to the linked device 114 are differentiated via, for example, a key word, phrase, or gesture provided by the user 104. For example, if the remote human interaction directed to the connected proxy device 112 is intended for the linked device 114, the user 104 may utter identification of the linked device, and/or utter some other keyword for notifying the controller 111 that commands are intended for controlling the linked device 114 and not the proxy device 112. In a more specific example, if the television 102b is the proxy device linked to the washing machine in the other room, a command directed to the television to “turn washer on” works to power on the washing machine instead of the television. However, a command directed to the television to “turn on” without identification of the linked washing machine, works to power on the television instead of the washing machine.

In one embodiment, prior to enabling control of the devices 102, 112, 114 via remote human interactions, the controller 111 is first initialized with information on the devices 102, 112 in the room. The information may include, for example, images of the objects in the room along with their location information. The images may be captured via a camera installed on the mobile device 116. In one embodiment, the images are forwarded to the server 108, which then processes the image data to generate a 3D map depicting the location of the devices 102, 112 in the room. The 3D map may provide, for example, the X, Y, Z location of the devices relative to the position of the mobile device 116 used to scan the objects in the room. The 3D map may then be provided to a module coupled to the camera 109 to offset the X, Y, Z, location information based on the location of the camera 109 that is used to capture the user's gestures. With this information in place, the user may then start engaging in remote human interactions with the objects in the room. It is assumed, of course, that the connected devices 102 will have completed the device registration process with the server 108 according to traditional mechanisms so that the connected devices are connected to the data network and are performing their intended functions.

FIG. 2 is a block diagram of various components of the interchangeable multimodal human interaction system according to one exemplary embodiment. The modules include, without limitation, a gesture recognition module 200, speech recognition module 202, controller 111, and multimodal application 204. Although the various modules used for the interchangeable multimodal human interaction system are assumed to be separate functional units, a person of skill in the art will recognize that the functionality of the modules may be combined or integrated into a single module, or further subdivided into further sub-modules. In one embodiment, the modules and/or sub-modules are software modules hosted in one or more computing devices in the room 100. For example, one or more of the modules may be hosted in the television 102b, hub 106, and/or a stand-alone computing device.

In one embodiment, the gesture recognition module 200 is configured to receive inputs from the camera 109 as the camera captures gestures of the user 104 as he interacts with one of the devices 102, 112 in the room. The captured gestures may be hand gestures, such as, for example, finger pointing, palm raised, raising of index finger, and the like. The gestures may also be provided with other parts of the body. For example, the gestures may be head movements, shoulders shrugging, leg movements, and/or other body motions.

In one embodiment, the gesture recognition module 200 is further configured to track eye movements for determining a direction in which the user's eyes are facing. A gaze input may then be generated based on the tracked eye movements. The gaze input may be used, for example, for determining selection of a device in the room.

In one embodiment, the camera is triggered to capture the user's image when a reference body part of the user is captured, such as, as for example, the head of the user along with his hand. In the embodiment where multiple users are in the room, the camera captures the gesture of the user closer to the camera 109, or the user who initiates the gesture first.

The camera 109 forwards the captured images of the gestures to the gesture recognition module 200 for processing. In this regard, the gesture recognition module 200 processes gestures intended for device selection and gestures intended for device control. In one embodiment, the processing of gestures intended for device selection includes determining a direction in which the user's finger or other body part is pointing, and identifying an object in the room mapped to that location. The identification process may entail accessing the 3D map of objects in the room generated by the server 108 during initialization of the system. In one embodiment, the 3D map provides X, Y, and Z locations of the objects in the room relative to the mobile device 116 that was used for system initialization. In one embodiment, the X, Y, and Z locations are automatically offset based on the location of the camera 109 capturing the gesture inputs, to generate a modified 3D map. A transformation (transf) matrix may be used to generate the modified 3D map.

In one example, the location of the objects in the room with respect to the camera 109 is obtained based on the following formula:

$${[ \begin{matrix}X \\ Y \\ Z\end{matrix} ]}_{Objects based on Camera} = {Transf}_{Camera Current}^{- 1} * {Transf}_{Camera Initial} * {[ \begin{matrix}X \\ Y \\ Z\end{matrix} ]}_{Objects Based On Mobile Device}$$

Transf_{CameraInitial} may be calculated as follows:

$${Transf}_{CameraInitial} = {[ {Translation}_{CameraInitial} ]}^{*} [ {Rotation}_{CameraInitial} ] * [ {Scale}_{CameraInitial} ]$$

$$Where , \\ {Translation}_{CameraInitial} = [ \begin{matrix}1 & 0 & 0 & {T}_{x} \\ 0 & 1 & 0 & {T}_{y} \\ 0 & 0 & 1 & {T}_{z} \\ 0 & 0 & 0 & 1\end{matrix} ]$$

$${Rotation}_{CameraInitial} = [ \begin{matrix}{R}_{11} & {R}_{12} & {R}_{13} & 0 \\ {R}_{21} & {R}_{22} & {R}_{23} & 0 \\ {R}_{31} & {R}_{32} & {R}_{33} & 0 \\ 0 & 0 & 0 & 1\end{matrix} ]$$

$${Scale}_{CameraInitial} = [ \begin{matrix}{S}_{x} & 0 & 0 & 0 \\ 0 & {S}_{y} & 0 & 0 \\ 0 & 0 & {S}_{z} & 0 \\ 0 & 0 & 0 & 1\end{matrix} ]$$

In one embodiment, a relationship between Initial Transformation matrix of camera and Transformation Matrix of mobile device is determined with respect to Camera.

In one embodiment, the following steps are executed for generating the 3D map of the objects in the room:
1. Mobile device calculates 3D map of surrounding (say using ARCore or ARkit or a proprietary way)
2. Mobile device finds TV and places 3 points based on a placed virtual object
3. Calculate orientation based on cross vector multiplication of 3 points
4. Mobile device represents Camera as an object in its frames
5. Inverse the camera representation and combine with orientation calculated in Step 3.
6. This becomes Transformation_{CameraInitial}
7. Upload Transf ormation_{CameraInitial} with 3D mapping on to remote server
8. Camera device downloads 3D map with this initial matrix
9. Uses the equation above to calculate offset of each objects

In another embodiment, a share mode in ARCore or ARkit may be used to determine the location of objects in the room relative to the camera. In this embodiment, the camera is a connected device that runs the same software with ArCore or Arkit enabled. Additional details on ARCore is found in https://developers.google.com/ar/develop/java/cloud-anchors/overview-android, the content of which is incorporated herein by reference.

Once generated, the modified 3D map may then be used by the gesture recognition module to identify the device in the room selected via a gesture.

In one embodiment, the gesture recognition module 200 generates a gesture event message based on a recognized gesture. The gesture event message may consist of, for example, a type of gesture along with one or more optional parameters. For example, in response to recognizing a finger-point gesture to a device in the room, the gesture recognition module may generate a gesture event message that identifies a “point” gesture that includes, as a parameter, an ID of the device receiving the point gesture. In another example, in response to recognizing movement of the user's index finger in an upwards direction, the gesture recognition module may generate a gesture event message that identifies an “index up” gesture that includes, as a parameter, a distance traveled by the index finger in the upwards direction.

If the user interaction is a voice command, the microphone 110 captures audio of the voice command and forwards the captured audio to the speech/audio recognition module 202. The recognized speech may then be used to generate an appropriate audio event message. In one embodiment, the recognized voice command need not include a trigger word or phrase preceding the command (e.g. “hi Alexa”) in order for the command to be interpreted. Thus, in one embodiment, the microphone is always active, and the speech recognition module constantly processes audio for recognized commands. The voice command also need not include identification of the device to which the command is directed (e.g. identification of “TV” in the command “turn on”). Although not required, the user may nonetheless provide the trigger word or phrase, or specifically identify the device, if desired, especially if the interchangeable multimodal human interaction system is to be backwards compatible with a traditional voice control system that may require such key words or phrases.

In addition to voice commands, the microphone 110 may also capture other audio commands generated via the user's mouth (e.g. a “shhh” sound), hands (e.g. clapping sound), and/or fingers (e.g. snapping sound). The speech/audio recognition module then generates appropriate audio event messages in response to the recognized audio.

As the user interacts with the devices in the room via different physical interactions, the gesture or audio event messages that are generated in response are forwarded to the controller 111 for further processing. The different event messages that correspond to the user's physical interactions may come in any order depending on how the user chooses to interact with the device. For example, the interactions may be gesture followed by voice, gesture followed by gaze, or gaze followed by voice. The different multimodal interactions may also be performed concurrently by the user.

In one embodiment, the event messages trigger the start or end of a communication session of a device to be controlled, and further advance the device through various states/modes of a state machine. As the event messages are received and the device progresses through the various states, the controller 111 determines the device that is to be controlled, and the control command directed to the device. In one embodiment, the controller 111 generates a computer input command based on the identified device and control command. The generated computer input command is transmitted to the appropriate multimodal application 204 via the data network for effectuating the commanded control of the device.

In one embodiment, the generating of the computer input command includes translating the event messages into native computer input commands of the device to be controlled. In this regard, the controller 111 may include a command repository that is configured to store a set of input event messages that are mapped to corresponding computer input commands in the native schema of the devices to be controlled. For example, a gesture input message indicating “index up (100 millimeters)” may be translated, based on the information in the command repository, to a computer input command indicating “increase volume (10 dBA).”

In one embodiment, a multimodal application 203 is installed in a central location such as, for example, the controller 111 or the hub 106, as a software module. The controller may transmit the computer input command to the appropriate multimodal application depending on the device that is to be controlled. Upon receipt of the command, the multimodal application transmits a signal to the device for performing the function directed by the computer input command (e.g. power on/off, increase/decrease volume, stop/play, etc.).

FIG. 3 is a state diagram of a state machine 300 that is run by the controller 111 for enabling control of the devices 102, 114 via interchangeable multimodal human interactions according to one exemplary embodiment. For ease of discussion, the possible multimodal interactions are deemed to be gesture and voice. Of course, as discussed above, gaze may also be another type of multimodal interaction provided by the user.

The state machine 300 starts in an initial state 302 where the controller waits/monitors for a user physical interaction. The physical interaction that is initially received by the controller may be a gesture selecting a device to be controlled, or a voice command indicative of a function to be performed (without first selecting the device).

If the initial physical interaction is a gesture indicating selection of a device 102, 112, a gesture event message corresponding to the gesture is received in act 304, and the controller initiates a communication session for the device. In one embodiment, a clock maintained by the controller is signaled to start at the start of the communication session.

In addition to starting the session, the state machine transitions to a selection state 306, where the state machine waits for a user physical interaction indicative of a control to be performed on the device. In one embodiment, the controller 111 waits/monitors for the user physical interaction until such interaction is detected in act 308, or the session expires in act 310. The session may expire, for example, after a certain period of time configurable by the user, such as, for example, 5 seconds.

The user physical interaction detected in act 308 may be a voice command or a gesture indicative of the control to be performed on the selected device. In response to receipt of an event message indicative of the user physical interaction in act 308, the state machine transitions to a device control state 312. In the device control state 312, the controller processes the voice or gesture event message, and forwards, via the data network, a corresponding computer input command to the multimodal application 204 of the identified device for executing the command.

The state machine stays in the device control state 312 until the session expires or a session close gesture is received, after which the state machine transitions to a session reset state 314. The session completes in act 315 upon the state machine transitioning to the session reset state, and the state machine returns to the initial state 302 where the controller waits for another physical user interaction.

Referring again to the initial state 302, if the initial user physical interaction received at the initial state is an audio event message corresponding to a voice control command 316 (e.g. power on/off, open/close, raise volume, etc.), the state machine transitions to a selection state 318 where the state machine waits for a user physical interaction that identifies a device 102, 112 in the room. A communication session is also initialized in response to the voice control command.

In one embodiment, the controller 111 waits for the user physical interaction until either such physical interaction is detected in act 320, or the session expires in act 322. In this regard, because the control command is received first prior to identification of the device, the controller stores the recognized voice control command in a buffer (or similar data store) until the device is identified or the session expires.

In one embodiment, the user physical interaction identifying the device in act 320 is a gesture captured by the camera 109 (e.g. an index finger pointing to the device). In some embodiments, the user 104 may employ eye movements (e.g. a gaze) to select the device 102, 112. Once the device is selected, the initialized communication session is associated with the selected device. Furthermore, the controller 111 retrieves the stored voice control command received in act 316, identifies a computer input command for the voice control command (e.g. based on the device that has been selected), and forwards the computer input command to the appropriate multimodal application 204 over the data network, for execution of the command.

In one example, if gaze is used for device selection, a special gesture may accompany the gaze in order to transition the device to the device control state 312. The special gesture may be, for example, opening the user's fist. Once in the control state, regular gestures may be used to control the device. The session may be terminated by a fist close gesture along with a gaze.

In one embodiment, the interchangeable multimodal human interaction system is backwards compatible with existing voice interaction systems. In this regard, in act 324, both the device selection and control command are provided via voice. Upon receipt, the state machine may transition directly to the device control state 312 for controlling the device according to the control command.

In the various embodiments, the multimodal interactions according to the various embodiments need not follow any preset sequence or order, but may be performed in any order that is natural to the individual user. Thus, the order of the physical interactions is interchangeable. For example, during one interaction, the device selection may be performed first, with the device control command being provided at a later point in time via another gesture or voice. During another interaction, a voice command of a function that is to be performed by a device may come first before a device is selected, and the selection of the device via gesture or gaze may be provided at a later point in time. During yet another interaction, the voice command and gesture device selection may be provided concurrently with each other.

Furthermore, the session-based control of the various devices in the room help provide a more reliable and accurate control of the devices when compared to other control systems. According to one embodiment, if there is a device 102, 114 in the selection state 306, 318 awaiting for a next human physical interaction, another session for another device in the room is not launched until the device transitions to the device control state 312. For example, a gesture device selection of the television 102b starts a session for the television and transitions the state machine to the selection state 306 where the television waits for a control command via another gesture or voice. While the controller 111 is waiting for the control command, another gesture attempting to select, for example, the lamp 102c, is ignored by the controller 111. In one embodiment, once the user provides the appropriate control command for the television 102b prior to expiration of the session with the television, the user may then initiate a session with the lamp (e.g. via gesture or voice). In an alternative embodiment, the controller 111 waits for the session with the television to end prior to allowing start of the session with the lamp. Thus, embodiments of the present disclosure provide technical improvements to multimodal control of devices in a room by enhancing reliability of control of such devices.

In one embodiment, interchangeable multimodal interactions may be used to not only control connected devices 102 in the room, but also certain devices outside of the room. The devices that may be controlled outside of the room are linked devices 114 (e.g. washing machine) that are linked to the proxy device 112 in the room. In this regard, the user wanting to control the linked device 114 engages in interchangeable multimodal interactions with the proxy device 112 in the room. The controller 111 is configured to recognize that user physical interactions directed to the proxy device 112 are intended for the linked device 114. In this case, the controller forwards control commands to the multimodal application controlling the linked device 114 instead of the proxy device 112.

FIG. 4 is a flow diagram of a process for interchangeable multimodal interactions with devices in a room that includes the proxy device 112 according to one exemplary embodiment. In act 400, the controller monitors and receives at least two multimodal physical interactions that are directed to the proxy device 112. The order of the multimodal physical interactions need not follow a preset order, and may consist of a combination of gesture, voice, and/or gaze. Transition of the state machine 300 based on the received physical interactions directed to the proxy device 112 may be as described with respect to FIG. 3.

Once the proxy device 112 is identified, and the control command has been received, the controller 111 determines, in act 402, whether to relay the control command to another device. In this regard, the controller 111 may search a device repository to determine whether the identified proxy device 112 is linked to another connected device (e.g. linked device 114). In one embodiment, the linking of the devices may occur via the application in the user's mobile device 106 during setup of the system. If the proxy device 112 is linked to another connected device, the controller 111 concludes that the control command is to be relayed to the linked device 114.

In the embodiment where the proxy device 112 itself can be controlled via multimodal interactions, the controller 111 further determines whether a key word, phrase, or gesture has been provided to indicate that the commands are meant for the linked device instead of the proxy device itself. The controller 111 concludes that the control command is to be relayed to the linked device 114 in response to detecting such key word, phrase, or gesture.

In act 404, the controller retrieves information for the linked device 404 including, for example, the command repository storing a set of input events messages that are mapped to corresponding computer input commands in the native schema of the linked device 114.

In act 406, the controller 111 generates a computer input command for the linked device 114 based on the mapping in the command repository.

In act 408, the controller 111 forwards the generated input command to the multimodal application 204 associated with the linked device 114, via the data network. The multimodal application 204 for the linked device 114 may be hosted, for example, in the device itself, or in the hub 106. The multimodal application then transmits appropriate signals to the linked device 114 for performing the function corresponding to the computer input command.

Referring again to act 402, if the interactions are not with the proxy device 112, the controller 111 determines that there is no need to relay the control commands to another device. In this case, the controller 111 retrieves, in act 410, information for the connected device 102 to which the multimodal interactions are directed, including, for example, the command repository storing a set of input events messages that are mapped to corresponding computer input commands in the native schema of the connected device 102.

In act 412, the controller 111 generates a computer input command for the connected device 102 based on the mapping in the command repository.

In act 414, the controller 111 forwards the generated input command to the multimodal application 204 associated with the connected device 102, via the data network. The multimodal application 204 for the connected device 102 may be hosted, for example, in the device itself, or in the hub 106. The multimodal application then transmits appropriate signals to the connected device 102 for performing the function corresponding to the computer input command.

FIG. 5 is a flow diagram of a process for generating a 3D map of objects in the room 100 according to an exemplary embodiment. In act 500, the user 104 invokes an appropriate application from, for example, the user's mobile device 116. The application may be downloaded to the user's mobile device upon purchase of the controller 111 (as a stand-alone application), or purchase of the device (e.g. television 102b) hosting the controller.

In one embodiment, the application provides instructions to the user 104 for generating the 3D map. For example, the application may instruct the user to stand in the middle of the room 100, and invoke the camera installed in the user's mobile device 116 to scan, in act 502, the objects in the room. Scanning the objects may entail capturing or snapping images of the objects, or merely placing the objects in the field of view of the camera.

In act 504, the application generates a 3D map depicting the location of the scanned objects in the room. The 3D map may provide, for example, the X, Y, Z location of the objects in the room relative to the position of the mobile device 116.

In act 506, images of the scanned objects along with the X, Y, Z location are uploaded to the server 108 over the data communication network.

In act 508, the 3D map is downloaded by, for example, the controller 111, and forwarded to the gesture recognition module 200. I some embodiments, the 3D map may be downloaded by the gesture recognition module 200 itself, or by some other software module coupled to the camera 109 used for capturing user gestures during a multimodal interaction.

In act 510, the controller 111 (or gesture recognition module 200) modifies the X, Y, Z location of the various objects so that the location is relative to the camera 109 instead of the mobile device 116. In this regard, the controller 111 determines the location of the camera 109 relative to the mobile device 116, and uses this information to generate an offset matrix to be applied to the X, Y, Z locations of the other objects in the room.

In act 512, the offset location information of the objects are stored for access by the gesture recognition module 200 for identifying objects based on the direction of gaze or gestures by the user 104.

In some embodiments, the controller 111, multimodal application 204, and the various modules, servers, and connected devices discussed above, are implemented in one or more processing circuits. The term “processing circuit” is used herein to mean any combination of hardware, firmware, and software, employed to process data or digital signals. Processing circuit hardware may include, for example, application specific integrated circuits (ASICs), general purpose or special purpose central processing units (CPUs), digital signal processors (DSPs), graphics processing units (GPUs), and programmable logic devices such as field programmable gate arrays (FPGAs). In a processing circuit, as used herein, each function is performed either by hardware configured, i.e., hard-wired, to perform that function, or by more general purpose hardware, such as a CPU, configured to execute instructions stored in a non-transitory storage medium. A processing circuit may be fabricated on a single printed circuit board (PCB) or distributed over several interconnected PCBs. A processing circuit may contain other processing circuits; for example a processing circuit may include two processing circuits, an FPGA and a CPU, interconnected on a PCB.

The terminology used herein is for the purpose of describing particular embodiments only and is not intended to be limiting of the inventive concept. As used herein, the terms “substantially,” “about,” and similar terms are used as terms of approximation and not as terms of degree, and are intended to account for the inherent deviations in measured or calculated values that would be recognized by those of ordinary skill in the art.

As used herein, the singular forms “a” and “an” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Expressions such as “at least one of,” when preceding a list of elements, modify the entire list of elements and do not modify the individual elements of the list. Further, the use of “may” when describing embodiments of the inventive concept refers to “one or more embodiments of the present disclosure”. Also, the term “exemplary” is intended to refer to an example or illustration. As used herein, the terms “use,” “using,” and “used” may be considered synonymous with the terms “utilize,” “utilizing,” and “utilized,” respectively.

Although exemplary embodiments of a system and method for knowledge distillation for model instances have been specifically described and illustrated herein, many modifications and variations will be apparent to those skilled in the art. Accordingly, it is to be understood that a system and method for knowledge distillation constructed according to principles of this disclosure may be embodied other than as specifically described herein. The disclosure is also defined in the following claims, and equivalents thereof.

What is claimed is:

1. A method for controlling an electronic device, the method comprising:
monitoring and receiving a first user physical interaction, wherein the first user physical interaction is provided at a first point in time;
determining a type of the first user physical interaction;
in response to determining that the first user physical interaction is of a first type:
identifying a device based on the first user physical interaction provided at the first point in time;
starting a session for the device;
while the session is unexpired, monitoring and receiving a second user physical interaction of a second type, wherein the second user physical interaction is provided at a second point in time, the second type being different from the first type; and
identifying a command based on the second user physical interaction provided at the second point in time; and
in response to determining that the first user physical interaction is of the second type:
identifying the command based on the first user physical interaction provided at the first point in time;
storing the command in a data store;
starting the session for the device;
while the session is unexpired, monitoring and receiving a third user physical interaction of the first type, wherein the third user physical interaction is provided at the second point in time; and
identifying the device based on the third user physical interaction provided at the second point in time; and
transmitting the command for controlling the device according to the command.

2. The method of claim 1, wherein the first type is a gesture or eye movement, and the second type is voice.

3. The method of claim 1, wherein the starting the session for the device includes:
determining that an unexpired session exists for another device;
identifying a state of the unexpired session; and
starting the session based on the state of the unexpired session.

4. The method of claim 1 further comprising:
invoking a camera on a mobile device;
detecting images of the device and a plurality of other electronic devices in an enclosed space via the camera; and
automatically determining a location of the device and each of the plurality of other electronic devices relative to a second camera invoked for identifying gestures of a user.

5. The method of claim 1, wherein the first, second, and third user physical interactions are determined to be directed to a second device other than the device, and the identifying of the device includes retrieving information correlating the second device to the device.

6. The method of claim 1, wherein the first point in time is concurrent with the second point in time.

7. The method of claim 1, wherein the second point in time is later than the first point in time.

8. The method of claim 1, wherein the command is for modifying an attribute of the device.

9. The method of claim 1, wherein in response to determining that the first user physical interaction is of the first type, transitioning a state machine associated with the device to a state that expects a next physical interaction from a user corresponding to a control command.

10. The method of claim 1, wherein in response to determining that the first type of interaction is of the second type, transitioning a state machine associated with the device to a state that expects a next physical interaction from the user corresponding to selection of a particular device.

11. A system for controlling an electronic device, the system comprising:
one or more processors; and
one or more memory devices coupled to the one or more processors, wherein the one or more memory devices store therein instructions that, when executed by the one or more corresponding processors, cause the one or more processors to respectively:
monitor and receive a first user physical interaction, wherein the first user physical interaction is provided at a first point in time;
determine a type of the first user physical interaction;
in response to determining that the first user physical interaction is of a first type:
identify a device based on the first user physical interaction provided at the first point in time;
start a session for the device;
while the session is unexpired, monitor and receive a second user physical interaction of a second type, wherein the second user physical interaction is provided at a second point in time, the second type being different from the first type; and
identify a command based on the second user physical interaction provided at the second point in time; and
in response to determining that the first user physical interaction is of the second type:
identify the command based on the first user physical interaction provided at the first point in time;
store the command in a data store;
start the session for the device;
while the session is unexpired, monitor and receive a third user physical interaction of the first type wherein the third user physical interaction is provided at the second point in time; and
identify the device based on the third user physical interaction provided at the second point in time; and
transmit the command for controlling the device according to the command.

12. The system of claim 11, wherein the first type is a gesture or eye movement, and the second type is voice.

13. The system of claim 11, wherein the instructions that cause the one or more processors to start the session for the device include instructions that cause the processor to:
determine that an unexpired session exists for another device;
identify a state of the unexpired session; and
start the session based on the state of the unexpired session.

14. The system of claim 11, wherein the instructions further cause the processor to:
Invoke a camera on a mobile device;
detect images of the device and a plurality of other electronic devices in an enclosed space via the camera; and
automatically determine a location of each of the plurality of electronic devices relative to a second camera invoked for identifying gestures of a user.

15. The system of claim 11, wherein the first, second, and third user physical interactions are determined to be directed to a second device other than the device, and the instructions that cause the processor to identify the device include instructions that cause the processor to retrieve information correlating the second device to the device.

16. The system of claim 11, wherein the first point in time is concurrent with the second point in time, or the second point in time is later than the first point in time.

17. The system of claim 11, wherein the command is for modifying an attribute of the device.

18. The system of claim 11, wherein the instructions further cause the processor to, in response to determining that the first type of interaction is of the first type, transition a state machine associated with the device to a state that expects a next physical interaction from the user corresponding to a control command.

19. The system of claim 11, wherein the instructions further cause the processor to, in response to determining that the first type of interaction is of the second type, transition a state machine associated with the device to a state that expects a next physical interaction from the user corresponding to selection of a particular device.

20. A system for controlling an electronic device, the system comprising:
a camera configured to detect physical interactions of a first type;
a microphone configured to detect physical interactions of a second type;
one or more processors coupled to the camera and microphone;
one or more memory devices coupled to the one or more processors, wherein the one or more memory devices store therein instructions that, when executed by the one or more corresponding processors, cause the one or more processors to respectively:
monitor and receive a first user physical interaction, wherein the first user physical interaction is provided at a first point in time;
determine a type of the first user physical interaction;
in response to determining that the first user physical interaction is of a first type:
identify a device based on the first user physical interaction provided at the first point in time;
start a session for the device;
while the session is unexpired, monitor and receive a second user physical interaction of a second type, wherein the second user physical interaction is provided at a second point in time, the second type being different from the first type; and
identify a command based on the second user physical interaction provided at the second point in time; and
in response to determining that the first user physical interaction is of the second type:
identify the command based on the first user physical interaction provided at the first point in time;
store the command in a data store;
start the session for the device;
while the session is unexpired, monitor and receive a third user physical interaction of the first type wherein the third user physical interaction is provided at the second point in time; and
identify the device based on the third user physical interaction provided at the second point in time; and
transmit the command for controlling the device according to the command.
